(19) United States
(12) Patent Application Publication
(10) Pub. No.: US 2003/0022666 A1
(43) Pub. Date: Jan. 30, 2003

(54) Apparatus and method for network management, communication apparatus, and network system

(76) Inventor: Kazuhiko Sato, Shinagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/151,068

(22) Filed: May 17, 2002

(30) Foreign Application Priority Data
Jul. 25, 2001 (JP) 2001-224050

(51) Int. Cl. H04Q 7/20

(52) U.S. Cl. 455/423; 455/41

(57) ABSTRACT

A management apparatus that manages a network comprises a controller that generates, when detecting a fault in the network, fault information including a description of the fault. The management apparatus further comprises a wireless communication module that communicates the fault information to a communication apparatus external to the network.

### BACKGROUND OF THE INVENTION

1. Field of the Invention

The present invention relates generally to management of a network, and more particularly, to fault management in a network.

2. Description of Related Art

Along with the recent spread of LANs and WANs (Wide Area Networks), many network devices, such as personal computers (“PCs” hereinafter) hubs, switches, and routers (“nodes” or “agents” especially for hubs) desire connection to a network and its subnets for information sharing and frequent communications.

Using distributed managements for such a network in structure, performance, security, and billing, it becomes difficult and expensive to locate and eliminate any fault in the network. In addition, distributed management is undesirable for risk management. Therefore, a centralized management of network statuses is needed.

In managing the network, a management apparatus (also called “manager” or “server”) is typically provided in the network to achieve a centralized management of the network, and informs an administrator of any fault occurring in the network via an indication device, such as a display. Such a notice enables the administrator to apply a countermeasure and remove the fault. Typically, the management apparatus monitors agents to which many PCs and interconnecting devices are connected. Network faults should be removed as soon as possible since they make network devices inactive or unstable.

However, conventional network management systems have disadvantages in that it is difficult to promptly inform the administrator of an event and description of a network fault, thereby delaying removal of the fault.

While centralized network management is in demand, not many networks have a sufficiently high frequency of faults as to require administrators to always stay physically near the management apparatus. Therefore, the administrator usually performs another job function and monitors the management apparatus regularly. Thus, the administrator does not notice the network fault as soon as the management apparatus indicates the fault because he is not constantly monitoring the management apparatus. Thus, there is a need for improved systems and methods to notify an administrator of a network fault.

### SUMMARY OF CERTAIN INVENTIVE EMBODIMENTS

Accordingly, one aspect of the present invention provides a network management apparatus, method and system for promptly informing the administrator and others, apart from the management apparatus, of the event and description of a fault when the management apparatus has detected the fault.

A management apparatus in one aspect of the present invention is configured to manage a network and comprises a controller, wherein the controller generates, upon detecting a fault in the network, fault information including a description of the fault, and a wireless communication module for radio transmission of the fault information to a communication apparatus external to the network. The wireless communication module may be a Bluetooth module configured to transmit the fault information using a Bluetooth communication standard.

In one aspect of the invention, the controller of the management apparatus generates fault information including the description of the fault, and may inform a user of the communication apparatus of the event and description of the fault. In addition, the management apparatus uses Bluetooth technology for radio transmission to the communication apparatus, and informs the user of the communication apparatus of the fault information without requiring him to inquire to a base station, etc. An operation of the management apparatus constitutes another aspect of the present invention, wherein the management method is programmable in a system.

In one aspect of the invention, the description of the fault may include, for example, a type of the fault, more specifically, a fault in a line in the network, and a fault in a network device connected to the network, thereby informing the user of the communication apparatus of the faulty line and network device. The description of the fault may include a location of the fault. This feature is convenient when the network is configured over many floors and/or many rooms on the same floor. The fault information may include audio information, and the Bluetooth module may include a converter that converts the audio information into a radio signal. Thereby, the fault information may include administrator's voice, which can be advantageous when the communication apparatus does not have a visual indication device. The fault information may include image information, and the wireless communication module may include a converter that converts the image information into a wireless signal. Thus, the communication apparatus may receive the fault information and display image information.

In one aspect of the invention, a managed device may be connected to the network, and the management apparatus may manage the network by monitoring connection and configuration statuses of the managed device. Thus, the managed device may more easily locate and remove faults by managing both the connection and configuration statuses.

A management system of another aspect of the present invention includes the above management apparatus configured to manage a network, and a communication apparatus that communicates with the management apparatus. In this case, the communication apparatus can be, for example, a portable terminal used by an administrator of the management apparatus, or a network device, connected to the network, used by an administrator of the management apparatus. A managed device may be connected to the network, wherein the management apparatus manages the network by monitoring connection and configuration statuses of the managed device, and wherein the fault information includes a countermeasure to eliminate the fault, and the communication apparatus is the managed device. In this case, a user of or a person near the managed device may remove the fault in accordance with the countermeasure.

A communication apparatus of still another aspect of the present invention that communicates with a management apparatus that manages a network includes a wireless communication module such as a Bluetooth module. As can be appreciated by one of ordinary skill in the technology, the communication module can comprise various sub-routines, procedures, definitional statements, and macros. The communication module can further comprise a plurality of additional modules, which are typically separately compiled and linked into a single executable program. The processes that are undergone by each of a plurality of modules may be arbitrarily redistributed to one of the other modules, combined together in a single module, or made available in a shareable dynamic link library.

In one aspect of the invention, the communication module may receive fault information including the description of a fault of the network from the management apparatus through a radio communication using Bluetooth technology, and the communication apparatus may further comprise an output device configured to output a description of the fault from the fault information that the communication module has received. Such a communication apparatus can use Bluetooth technology configured to receive the fault information, and the output device may inform its user of the event and description of the fault.

In one aspect of the invention, the wireless communication module may include a converter that converts a radio signal into audio information, and the output device may include a speaker to output the audio information. Thus, the user of the communication apparatus may obtain instructions or information via an administrator's voice transmission. The wireless communication module may include a converter that converts a radio signal into image information, and the output device may include an indication or visual display device that displays the image information. Thus, the communication apparatus may obtain the fault information as image information.

In one aspect of the invention, the communication apparatus may further include a memory configured to store a symbol that identifies the description of the fault, wherein the output device may include a visual indication device, or display, that indicates the symbol. Alternatively, the description of the fault may include information on a type and a location of the fault, and the communication apparatus may include a first memory that stores a first symbol that identifies the type of the fault, a second memory that stores a second symbol that identifies the location of the fault, and a controller that generates a third symbol by combining the first symbol with the second symbol in accordance with the fault information, and wherein the output device may include a display that indicates the third symbol. The symbol enables the user of the communication apparatus to recognize the description of the fault at a glance. The symbol may be an icon, and when the icon is selected the display may hierarchically indicate details of the fault. Thereby, the user of the communication apparatus may obtain detailed information of the fault while located away from the management apparatus.

In one aspect of the invention, the communication apparatus may further include a memory that stores a countermeasure instruction to eliminate the fault, and the output device may further output the countermeasure instruction that corresponds to the description of the fault. Thus, the user of the communication apparatus can obtain the description of the fault and the countermeasure against it, and may remove the fault or command the removal of the fault.

Other features of the present invention will become readily apparent from the following description of preferred embodiments with reference to accompanying figures.

### BRIEF DESCRIPTION OF THE FIGURES

FIG. 1 is a system diagram of a network management system of one aspect of the present invention.

FIG. 2 is an exemplary illustration of a management file stored in a memory of a management apparatus in the network management system shown in FIG. 1.

FIG. 3(A) is an additional exemplary illustration of a management file stored in the memory of the management apparatus shown in FIG. 1.

FIG. 3(A) is an additional exemplary illustration of a management file stored in the memory of the management apparatus shown in FIG. 1.

FIG. 4(A) is an illustration of an icon to be displayed on a communication apparatus in the network management system shown in FIG. 1.

FIG. 4(B) is an illustration of another icon to be displayed on a communication apparatus in the network management system shown in FIG. 1.

FIG. 5 is a flowchart illustrating one embodiment of the operation of the management apparatus in the network management system shown in FIG. 1.

FIG. 6 is a flowchart illustrating one embodiment of the operation of a wireless communication module sending fault information to the communication apparatus in the network management system shown in FIG. 1.

FIG. 7 is a flowchart illustrating one embodiment of a method of automatically creating the management file shown in FIG. 2.

FIG. 8 is an example of the management file in a transient state to produce the management file shown in FIG. 2.

FIG. 9 is a flowchart illustrating one modified embodiment of the method shown in FIG. 7.

### DETAILED DESCRIPTION OF CERTAIN EMBODIMENTS

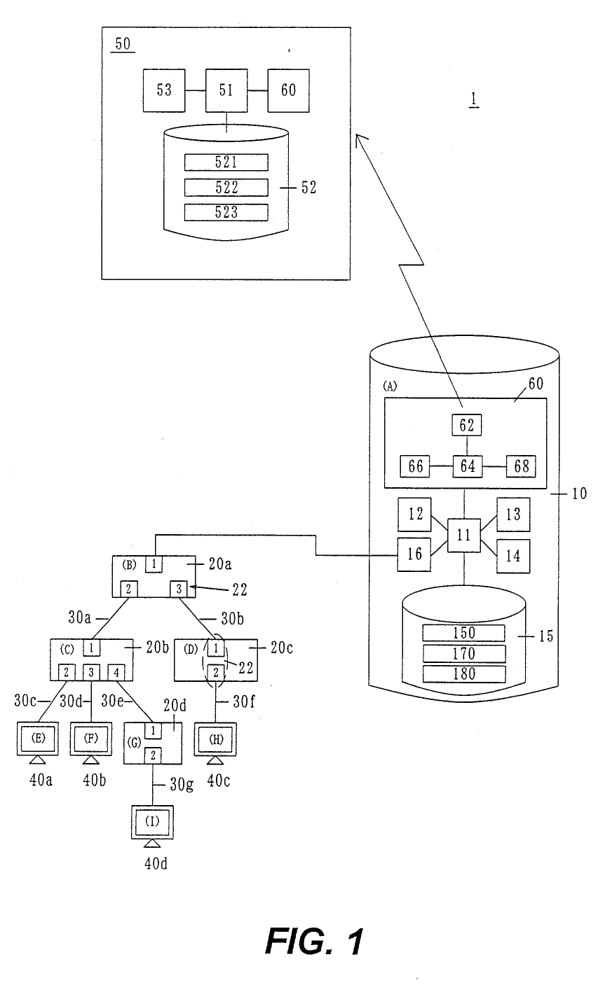

A description will now be given of a network management system 1 of the present invention with reference to the accompanying figures. FIG. 1 shows an architecture diagram of the network management system of the present invention. The network management system 1 includes, as illustrated, a management apparatus 10, interconnecting devices 20a-20e (generalized by “20”), an Ethernet 30, devices 40a-40d (generalized by “40”), and a communication apparatus 50.

Unique device identification informations A-I are assigned to the management apparatus 10, interconnecting devices 20, and devices 40, respectively. The device identification information may include, for example, a MAC (Media Access Control) address to identify the information device to be connected to the LAN.

The management apparatus 10 may be a network device configured to manage the Ethernet 30, outputs, when detecting a fault in the Ethernet 30, the fault, and can inform the communication apparatus 50 of the event and the description of the fault by a radio transmission using wireless communication device such as a Bluetooth device. The management apparatus 10 includes, as shown in FIG. 1, a controller 11, an input/output (I/O) device 12, a RAM (Random Access Memory) 13, a ROM (Read Only Memory) 14, a memory 15, a communication port 16, and a wireless communication module, which is implemented in one embodiment as a Bluetooth module 60.

Bluetooth refers to a short-distance radio communication standard capable of connecting devices such as PCs, peripherals, cellular phones, and information terminals to each other by a spread spectrum packet communication scheme, and includes a synchronous transmission channel for audio transmission and an asynchronous transmission channel for data transmission. The current connectable range for Bluetooth is about 10 m, but can be extendable up to about 100 m using an additional amplifier. Other wireless networking technologies, such as IEEE 802.11 may also be employed.

The controller 11 can be a processor, such as a CPU or an MPU, and can control each component in the management apparatus 10. The management apparatus 10 can be connected to a host (not shown), and the controller 11 can communicate with the host. The controller 11 can execute a fault detection program stored in the memory 15, communicate with the interconnecting device 20, and detect a fault in the Ethernet 30. In addition, the controller 11 can generate fault information including the description of the detected fault, and transmit the fault information to the communication apparatus 50 via the Bluetooth module 60. The controller 11 can also receive a request from the Bluetooth module 60, and obtain and send details of the fault information in response to this request.

In this embodiment, the fault information includes a type and location of the fault. The type of fault can include a fault in a link (or line) and a fault in the device. The fault in the device can include a fault in the interconnecting device 20 as well as a fault in the device 40. The fault information may change depending upon a type of the communication device 50. For example, if there are two communication devices 50, a first communication device may have a smaller display, and the second communication device may have a large display with a speaker, and the fault information to be sent to the first communication device may include a symbol representative of the fault, and the fault information to be sent to the second communication device may include a detailed statement and audio/voice information.

The I/O device 12 can be a keyboard, a mouse, other pointing devices, a microphone, a camera, a display, a printer, other image output devices, a speaker, or another type of audio output device. Using the I/O device 12, an administrator of the management apparatus 10 can obtain, for example, details of the fault in the Ethernet 30, and a countermeasure to the fault. The administrator may enter voice information through the microphone and image information through the camera.

The RAM 13 can temporarily store data to be read from the ROM 14 or the memory 15, or data to be written in the memory 15 or the like. The ROM 14 can store various kinds of software, firmware, and other types of software for use with operations for the controller 11.

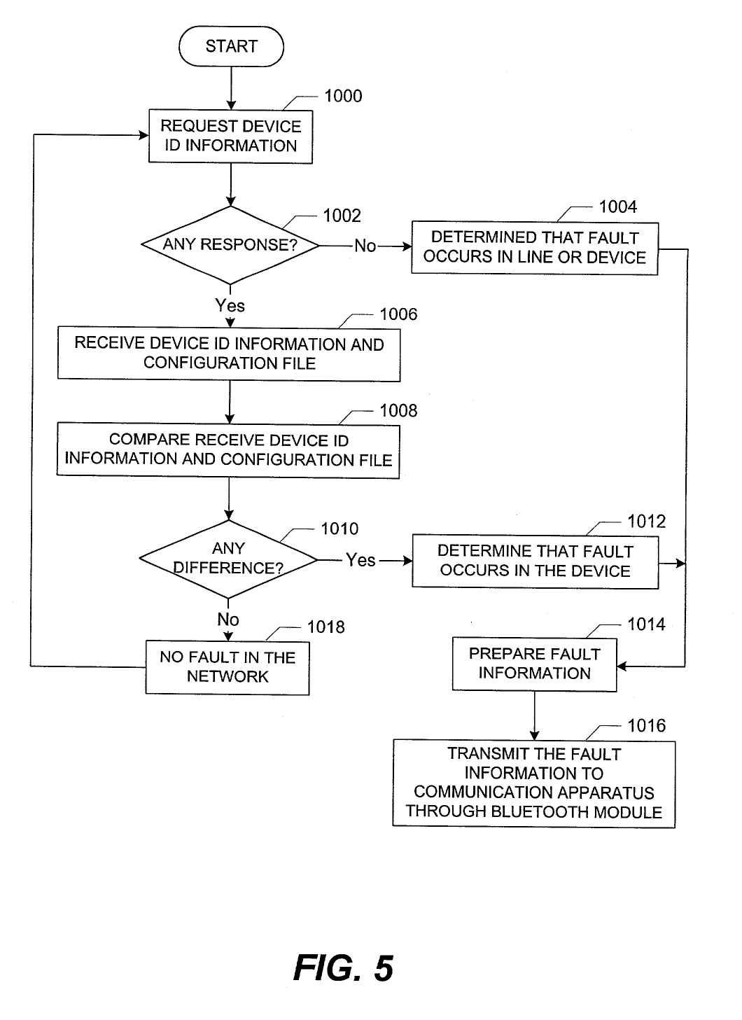

The memory 15 can store data for a control method that is executed by the management apparatus 10 and will be described in more detail with reference to FIG. 5. Such a control method may be distributed as an independent product. Therefore, it may be sold in a CD-ROM storage format or other recordable media, or distributed and updated online via a network such as the Internet.

The memory 15 may further include management files 150, 170 and 180. Alternately, these management files 150, 170 and 180 may be integrated as one file.

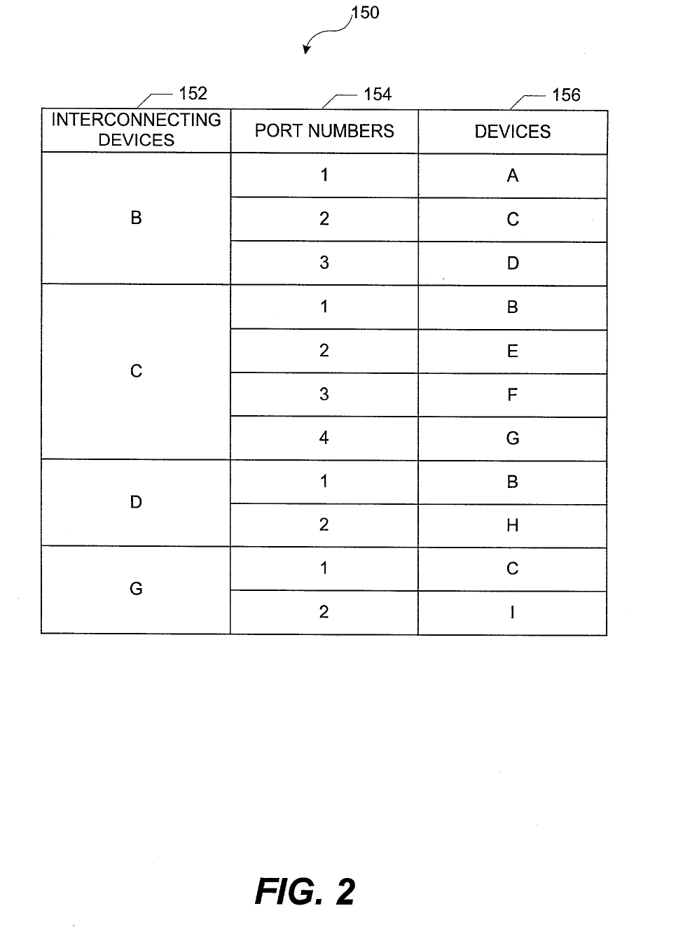

The management file 150 can store connection information to detect a fault in the Ethernet 30, and is illustratively indicated as a table in FIG. 2. As illustrated, the management file 150 comprises an “INTERCONNECTING DEVICES” field 152 that identifies the interconnecting device 20, a “PORT NUMBERS” field 154 that identifies a port number of the interconnecting device 20, and a “DEVICES” field 156 that identifies a device connected to the interconnecting device 20. The “DEVICES” listed in the devices field 156 include the management apparatus 10, interconnecting devices 20, and devices 40. FIG. 2, as used herein, illustrates an exemplified structure of the management file 150. The management file 150 can be manually created by the administrator, or automatically created by the controller 11 as a result of communications with the interconnecting devices 20 and/or devices 40.

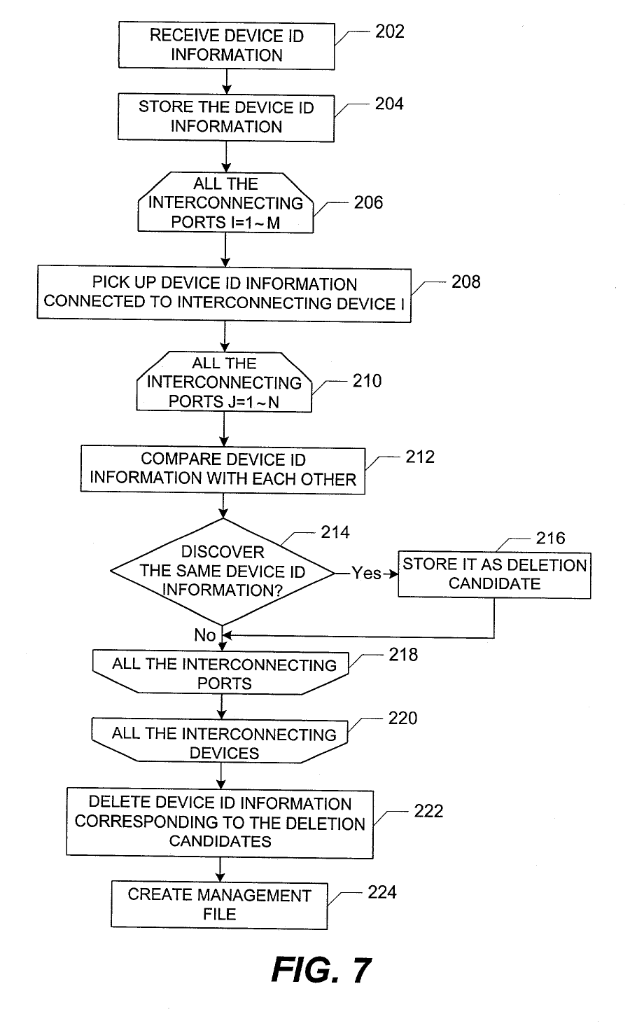

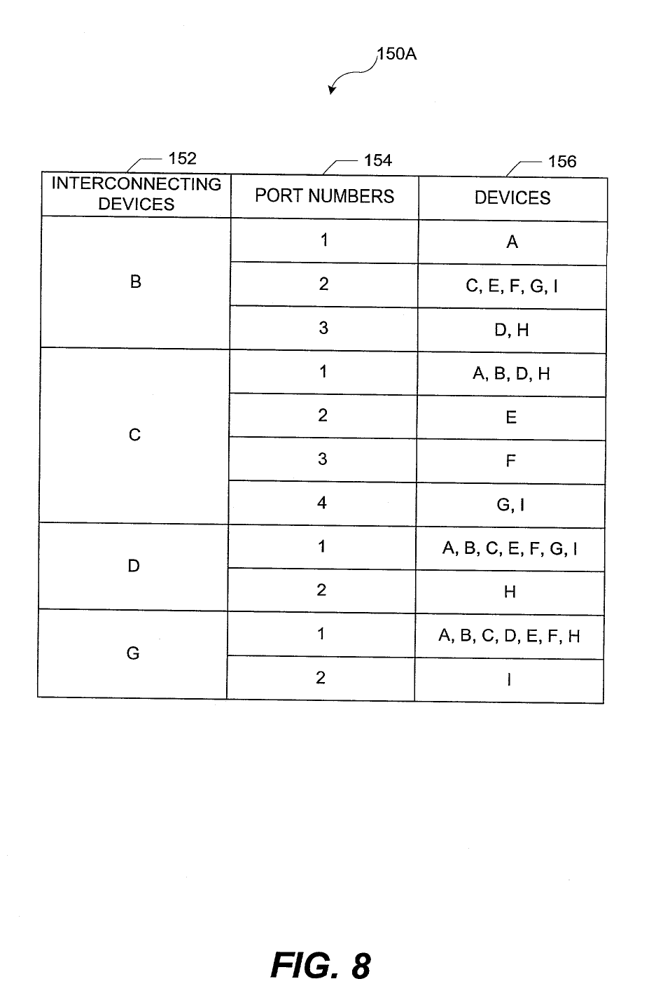

A description will now be given of a method of automatically creating the management file 150 by the controller 11, with reference to FIGS. 7 and 8. FIG. 7, as used herein, is a flowchart illustrating an example of an automatic creating method of the management file 150. Initially, in a state 202, the controller 11 receives, from interconnecting devices 20, device identification (ID) information that each interconnecting device 20 memorizes for each port 22 state. Next, in a state 204, the controller 11 stores the device ID information received from all m-piece interconnecting devices 20, and creates a management file 150a, shown in FIG. 8. FIG. 7 generally states I=1˜M, however, M=4 in this embodiment. FIG. 8, as used herein, is an example of the management file 150a in a transient state before the management file 150 is completed.

Referring now to FIG. 8, the devices field 156 includes device ID information of those devices indirectly connected to the interconnecting devices 20, as well as device ID information of those devices directly connected to the interconnecting devices 20. When one interconnecting device “I” is picked up in a state 208, the processes of states 212-216 are performed for all of the n ports in the interconnecting device I in a state 210. In a state 206, the controller 11 performs the processes performed from states 212-216 for all of the M-piece interconnecting devices 20 that have transmitted the device ID information in a state 206.

In a state 212, the controller 11 compares device ID information a (e.g., devices C, E, F, G, and I) that has been stored while associated with a j-th port (e.g., port no. 2) of the interconnecting device I (e.g., an interconnecting device B) with device ID information of an interconnecting device I′ (e.g., an interconnecting device C, D or G) that has device ID information β (e.g., devices D and H) that has been stored while associated with a non-j-th port (e.g., port no. 3) of the interconnecting device I.

The state 212 moves to the next port when the device ID information a does not include the device connected to interconnecting device I′ in a state 214. When the device ID information α includes the device connected to interconnecting device I′ in states 212 and 214, the device is stored as a deletion candidate in a state 216.

After a process for all the ports is conducted in a state 218 and a process for all the interconnecting devices is conducted in a state 220, device ID information as the deletion candidates stored in the state 216 is deleted from the management file 150a in FIG. 8 in a state 222, whereby the management file 150 shown in FIG. 2 is created Figure based on the stored device ID information in a state 224.

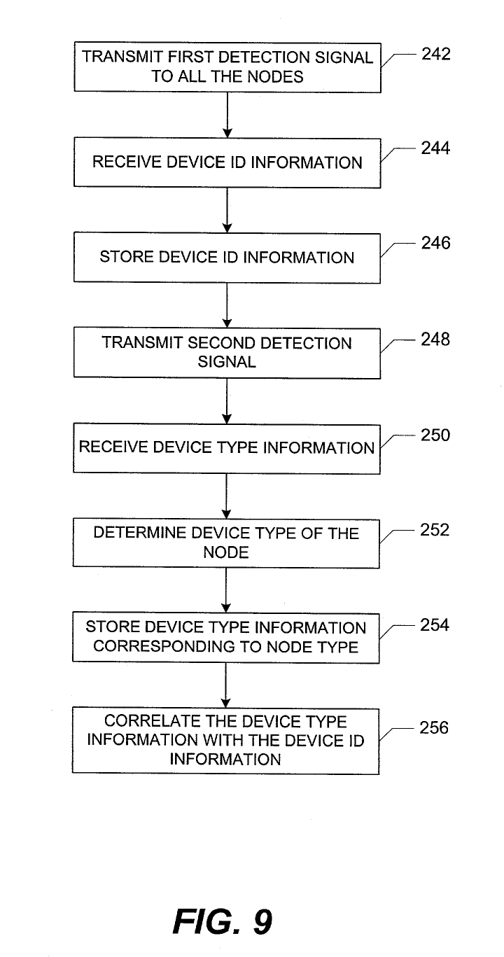

A description will now be given of an exemplary modification of the method shown in FIG. 7. FIG. 9, as used herein, is a flowchart illustrating another method used by the controller 11 for automatically creating the management file 150.

Initially, in a step 242, the controller 11 sends a first detection signal using a broadcast to a plurality of nodes (i.e., interconnecting devices 20 and devices 40) in the Ethernet 30, and then, in a step 244, the controller receives device ID information from a node that has received the first detection signal. Then, in a step 246, the controller 11 stores the received device ID information of the node, and transmits a second detection signal to the node based on the stored device ID information of the node in a step 248. Next, in a step 250, the controller 11 receives device type information corresponding to the second detection signal from the node that has received the second detection signal, and, in a step 252, determines a device type of the node based on the received device type information of the node. Then, in a step 254, the controller 11 stores device type information with a corresponding device type of the node, thus correlating the device ID information with the device type information in a step 256. As a result, the controller 11 can create the management file 150.

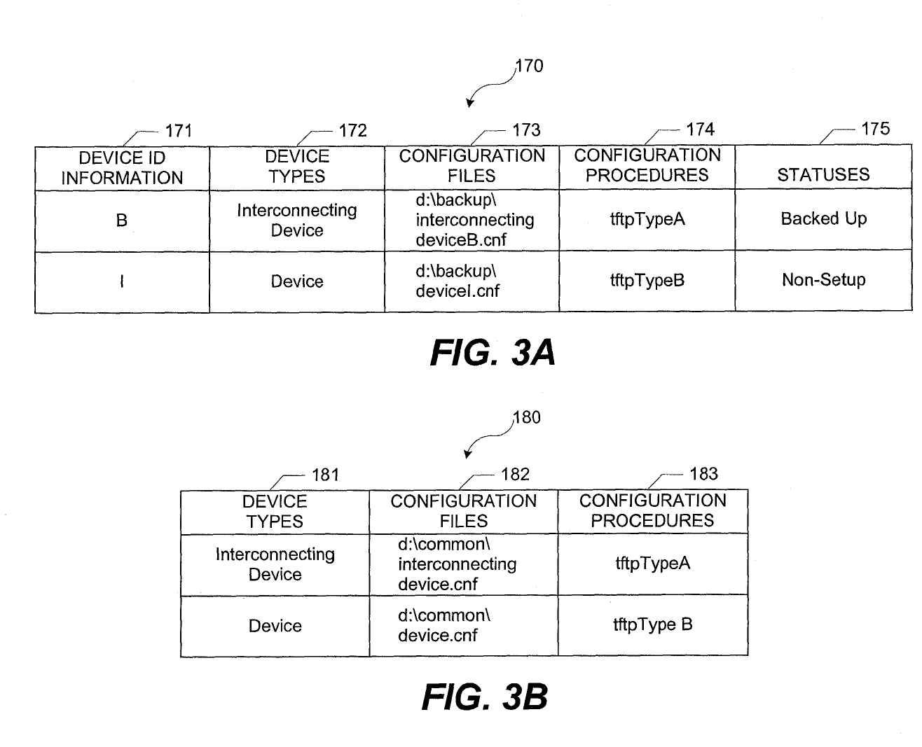

The memory 15 may further include the management file 170 shown in FIG. 3(a) and the management file 180 shown in FIG. 3(b). FIGS. 3(a) and 3(b), as used herein, are examples of management files 170 and 180. Each of the management files 170 and 180 store configuration information, however, these files differ in that the management file 170 identifies configuration information that is different depending upon devices connected to the Ethernet 30.

The management file 170 stores configuration information to detect a fault in the Ethernet 30, and includes a “DEVICE ID INFORMATION” field 171, a “DEVICE TYPES” field 172, a “CONFIGURATION FILES” field 173, a “CONFIGURATION PROCEDURES” field 174, and a “STATUS” field 175.

The device ID information field 171 identifies a device connected to the Ethernet 30. The device types field 172 identifies a type of the device connected to the Ethernet 30. The configuration files field 173 stores management information set up by the management apparatus 10 in the interconnecting devices 20 and devices 40. The configuration procedures field 174 stores a procedure by which the management apparatus 10 sets up information in the interconnecting devices 20 and devices 40. The statuses field 175 identifies whether the configuration file is backed up.

The management file 180 is a management file that is common to each type of devices connected to the Ethernet 30. The management file 180 is referred to when the configuration file has not been set up in the management file 170. The management file 180 includes a “DEVICE TYPES” field 181 that identifies a type of apparatus connected to the Ethernet 30, a “CONFIGURATION FILES” field 182 that is common to each type of devices, and a “CONFIGURATION PROCEDURES” field 183 that stores a procedure common to each type of devices.

The administrator may produce the management files 170 and 180, or the controller 11 may automatically produce them. A description will now be given of the latter method. When network devices, such as the interconnecting devices 20 and devices 40, are connected to the Ethernet 30 and turned on, the network device appends its unique identifier and requests an address acquisition by broadcasting to the Ethernet 30.

When the controller 11 receives the address acquisition request, it obtains a provisional address to be assigned to the network device based on an identifier unique to the received network device. Next, the controller 11 informs the network device of controller 11's address using, for example, a DHCP (Dynamic Host Configuration Protocol).

The network device sets up its address to be the provisional address, and sends a configuration information acquisition request to the address of the management apparatus 10 using, for example, an SMTP (Simple Network Management Protocol).

In response to the configuration information acquisition request, the controller 11 sends the configuration information to the network device, and creates the management files 170 and 180. The network device then stores the received configuration information.

Referring back to FIG. 1, the communication port 16 may be an LAN adapter connectable to the Ethernet 30, a USB port or IEEE 1394 port connectable to the Internet (as necessary, via an internet service provider (ISP)) via a modem, a terminal adapter (TA) through the public telephone network, ISDN, or various types of such dedicated lines.

The wireless communication module 60 converts the fault information generated by the controller 11 into a radio signal, transmits the radio signal to the communication apparatus 50 using the Bluetooth protocol, for instance, and receives information from the communication apparatus 50. As can be appreciated by one of ordinary skill in the technology, transmission signals and methods other than radio, such as microwave and optical, can also be used in the management system described herein.

The wireless communication module 60 integrates Bluetooth technology, and comprises a wireless transceiver 62, a processor 64, a first converter 66, and a second converter 68.

The wireless transceiver 62 transmits a radio signal that the Bluetooth module 60 has converted and receives the radio signal. The wireless transceiver 62 may apply any structure known in the technology, for example, including a D/A converter, a low pass filter, a FM modulator, a burst modulator in the transmitter and an IF filter, an FM modulator, a threshold detector/clock recovery, and a frequency hopping controller in the receiver.

The processor 64 can communicate with the controller 11 and control each part of the wireless communication module 60. More specifically, the processor 64 comprises a DSP (digital signal processor), for example, to control audio and image signals, links, packets, error corrections, securities, data randomization, etc.

The first converter 66 can convert a radio signal into audio information, and audio information into a radio signal. The second converter 68 can convert a radio signal into image information, and image information into a radio signal. The processor 64 can receive, from the controller 11, audio information to be supplied to the first converter 66, and image information to be supplied to the second converter 68. The processor 64 can transmit audio information converted by the first converter 66 and image information converted by the second converter 68 to the controller 11.

The interconnecting device 20 is a network device configured to connect another interconnecting device 20 and device 40 to the Ethernet 30, and includes one or more ports 22 connectable to another interconnecting device 20 and device 40. In FIG. 1, the port 22 is illustrated as a rectangular shape with a numeral. The interconnecting device 20 may include, for example, a hub, a switch, a router, other concentrators, a repeater, a bridge, a gateway device, a PC, and a wireless interconnecting device (e.g., an access point as an interconnecting device for a wireless LAN).

The present embodiment uses the Ethernet 30 as a typical example of LAN. The Ethernet 30 is a bus type LAN including 10Base-T, 100Base-TX, Gigabit Ethernet, and the like, but the present invention is applicable to other types of LAN (e.g., token ring), and networks other than LAN such as WAN (Wide Area Network), MAN (Metropolitan Area Network), private network, the Internet, commercial dedicated lines network (e.g., America Online), and other networks.

The device 40 can be a network device, such as a hub, a switch, a router, other concentrators, a repeater, a bridge, a gateway device, a PC, a server, or a wireless interconnecting device (e.g., an access point as an interconnecting device for a wireless LAN).

The communication apparatus 50 receives fault information from the management apparatus 10 that has been converted into a radio signal, and informs a user of the communication apparatus 50 of the fault information by display and/or voice. The user of the communication apparatus 50 is typically the administrator of the management apparatus 10. As a result, the communication apparatus 50 eliminates the need of the administrator to always stay near the management apparatus 10, and enables him to easily perform both another job function and a network management administration function using the management apparatus 10. However, according to the present invention, the communication apparatus 50 may include a communication apparatus of a maintenance person of the Ethernet 30 and devices 40, the faulty device 40, and communication apparatuses of persons who have and are located near the faulty device 40. Since the wireless communication module 60 may send voice information of the administrator of the management apparatus 10, a maintenance person, or a user of the faulty device etc. may remove the fault in accordance with the voice information from the administrator.

The communication apparatus 50 includes, for example, a cellular phone, a Personal Handy-phone System, a personal digital assistant (PDA), a personal computer (PC), a digital camera, a digital television, a game machine, and other devices. Thus, the communication apparatus 50 may be a portable terminal of the administrator who handles the management apparatus 10, or a PC of the administrator at a desk apart from the management apparatus 10. The communication apparatus 50 can include Bluetooth communication technology and associated functions as well as its original functions (for example, functions of a cellular phone), however, a description of the original functions of the communication apparatus is omitted in the present embodiment.

The communication apparatus 50 includes, as shown in FIG. 1, a controller 51, a memory 52, an output device 53, and a wireless communication module 60. The communication apparatus 50 may use Bluetooth technology, and thus reliably receive the fault information occurring in the network.

The controller 51 can be a processor, such as a CPU or an MPU, and can control each component in the communication apparatus 50. As concerned with the present invention, the controller 51 can indicate or output the fault information as it is transmitted from the management apparatus 10, or create and indicate a notice symbol 511 by combining a fault type symbol 525 with a location symbol 526 in the memory 52 in accordance with the fault information, as will be described later. In the former case, the controller 11 may prepare the notice symbol 511 and send it to the communication apparatus 50.

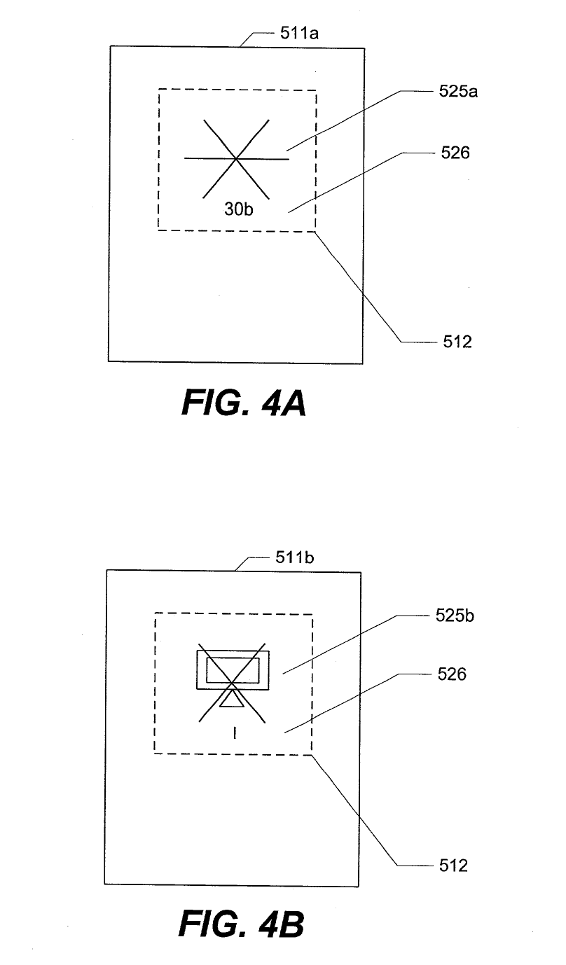

The following is a description of a case where the controller 51 prepares the notice symbol 511, with reference to FIG. 4. FIGS. 4(A) and 4(B), as used herein, illustrate an example of the notice symbol 511. FIG. 4(A) is a notice symbol 511a that informs that a fault occurs in a line in the Ethernet 30, while FIG. 4(B) is a notice symbol 511b that informs that a fault occurs in the device 40 or interconnecting device 20.

The notice symbols 511a and 511b include a field of icon 512 that combines a fault type symbol 525 with a location symbol 526. In this embodiment, when the icon 512 is executed, details of the fault occurring in the network are hierarchically indicated like a tree. In order to reduce the amount of data transmitted using Bluetooth and the amount of data output at one time from the communication apparatus 50, this embodiment uses the icon to easily and hierarchically output the description of the fault.

The memory 52 can store a fault type management table 521, a fault location management table 522, and a fault countermeasure management table 533.

The fault type management table 521 can store a fault type symbol 525 that identifies whether a fault occurring in the network relates to a device or a line. The fault type symbol 525 can include, as shown in FIGS. 4(a) and 4(b), a fault type symbol 525a indicating that a fault occurred in a line in the Ethernet 30, a fault type symbol 525b indicating that a fault occurred in a device in the Ethernet 30. The fault type management table 521 may correlate, for example, a signal “101” with the fault type symbol 525a, and a signal “110” with the fault type symbol 525b. Thereby, the controller 51 may obtain the fault type symbol corresponding to the signal received from the management apparatus 10.

The fault type management table 521 stores detailed information of the description of the fault, and enables, if necessary, the output device 53 to hierarchically indicate the description. The detailed information includes, for example, “the apparatus I has a different MAC address”, “files are not readable, writable, printable, etc”. As described above, the detailed information can be stored while correlated with the signal. Thereby, the controller 51 may obtain detailed information corresponding to the signal received from the management apparatus 10.

The fault location management table 522 stores a location symbol 526 that identifies a location of a fault in the network. Referring to FIG. 4, the location symbol 526 may be, for example, the device ID information B-I of the interconnecting devices 20 and devices 40, and links 30a-30g in the Ethernet 30. The detailed information is also stored and correlated with the signal. Thereby, the controller 51 may obtain information on a fault location corresponding to the signal received from the management apparatus 10.

The fault location management table 522 may also store detailed information on a location of a fault. The detailed information may identify, for example, a floor, a department, a room number on which the faulty device or link is located, a username, and user's extension. The detailed information can be stored while correlated with the signal, as described above. Thereby, the controller 51 may obtain detailed information corresponding to the signal received from the management apparatus 10.

The fault countermeasure management table 523 stores countermeasure information 527 to remove faults occurring in the Ethernet 30. The countermeasure information 527 may include instruction strings, for example, “reset MAC address”, “change cable”, etc. As described above, the information can also be stored while correlated with the signal, whereby the controller 51 may obtain information on a countermeasure corresponding to the signal received from the management apparatus 10.

The output device 53 may include a speaker that outputs an audio signal having fault information from the management apparatus 10, an indication device that outputs, as image information, fault information from the management apparatus 10, etc. The administrator may recognize the event and description of a fault through the output device 53. The communication apparatus 50 further includes an input device, and may use the input device to switch the content of the information output by the output device 53 and to enter information to be sent to the management apparatus 10.

The wireless communication module 60 can receive a radio signal representative of fault information generated by the management apparatus 10, and output it as audio and/or image information from the output device 53. Therefore, when the communication apparatus 50 is located out of use range for its original function (e.g., a function of a cellular phone), it is possible to send and receive the description of a fault occurring in the network to and from the communication apparatus 50, if the distance between the communication apparatus 50, including therein the wireless communication module 60 and the management apparatus 10, is within a distance allowed by the wireless communication protocol, e.g., 10 m (or 100 m when using an additional amplifier). Such a communication distance is long enough to cover most company office locations using the normal Ethernet 30, and thus the communication apparatus 50 may consistently receive the fault information from the management apparatus 10.

A description will now be given of an operation of the inventive network management system 1 with reference to FIG. 5. FIG. 5 is a flowchart illustrating the operation of the management apparatus 10 as it detects a fault in the network management system 1.

Initially, in a state 1000, the controller 11 requests the interconnecting devices 20 in the Ethernet 30 to transmit device ID information that respective interconnecting devices 20 store for each port 22. In a state 1002, if the interconnecting apparatus 20 does not respond to the request from the controller 11, the controller 11 determines that a fault has occurred in a line or device in the Ethernet in a state 1004.

When the interconnecting device 20 responds to the request by the controller 11 in state 1002, the controller 11 receives the device ID information that the respective interconnecting apparatus 20 stores for each port 22 and a configuration file in a state 1006. Then, in a state 1008, the controller 11 compares the data received from the interconnecting device 20 with data in the management file 150 in the memory 15, and the received configuration file with data in the management file 170 in the memory 15.

If the comparison results in a disaccord in state 1008, the controller 11 determines that a fault has occurred in the device that has the disaccord in a state 1012. If the comparison results in an accord in state 1008 and state 1010, the controller 11 determines that there is no fault in the Ethernet 30 and returns to state 1000 in a state 1018.

In a state 1014, the controller 11 prepares fault information in case of states 1004 and 1012. The controller 11 generates the fault information by extracting a type of the fault (i.e., a fault in the network line or a fault in the network device), and a location of the fault. Then, in a state 1016, the controller 11 transmits the prepared fault information to the communication apparatus 50 through the Bluetooth module 60. The controller 11 may indicate on a display device whether audio information should be sent. In response, the administrator of the management apparatus 10 may enter a countermeasure to the fault as voice information.

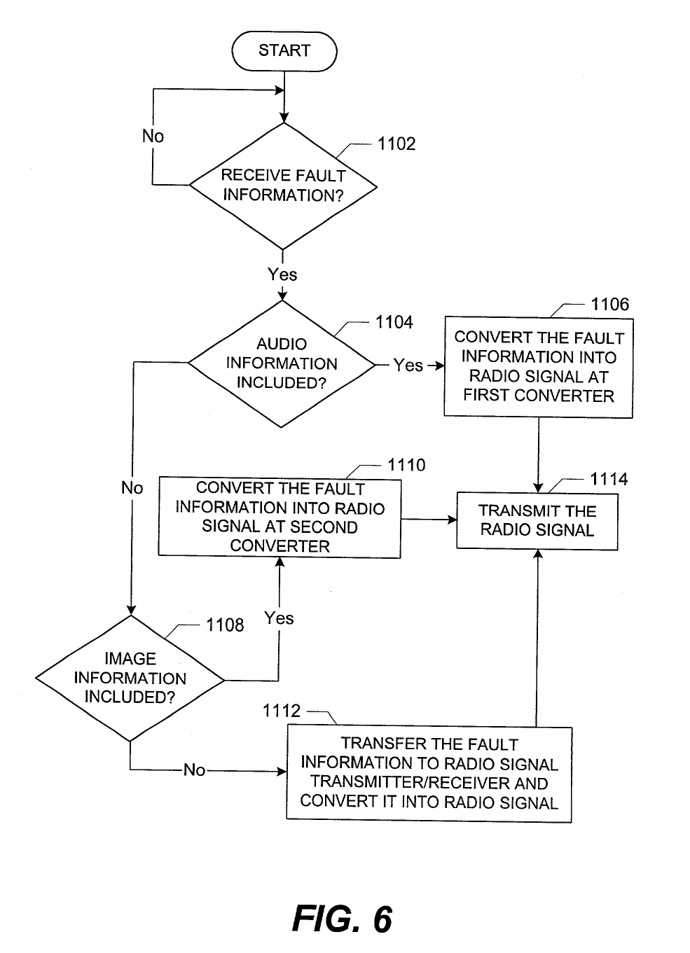

FIG. 6 is a flowchart illustrating an operation of the wireless communication module 60 sending fault information. First, in a state 1102, the processor 64 determines if it receives fault information from the controller 11. Then, in a state 1104, the processor 64 determines, when determining that it has received the fault information in state 1102, whether the fault information includes audio information. The processor 64, when determining that the fault information includes audio information in state 1104, transfers the fault information to the first converter 66 to convert it into a radio signal in a state 1106.

Next, in a state 1108, the processor 64 determines whether the fault information includes image information. The processor 64, when determining that the fault information includes image information in state 1108, transfers the fault information to the second converter 68 to convert the image information into a radio signal in a state 1110.

In a state 1112, the processor 64, when determining that the fault information includes a regular signal that is neither audio information nor image information, transfers the fault information to the wireless transceiver 62 to convert it into a radio signal.

As a result of states 1106, 1110 and 1112, the fault information is converted into the radio signal and sent from the wireless transceiver 62 to the communication apparatus 50 in a state 1114.

The following is a description of the operation of the communication apparatus 50 that receives fault information. When the wireless transceiver 62 in the Bluetooth module 60 receives the signal from the management apparatus 10, the processor 64 extracts the audio information at the first converter, image information at the second converter, and other information at the wireless transceiver 62, and then transfers the resultant information to the controller 51.

The controller 51 indicates the fault information on the output device 53 when the information includes the image information of the icon 512, and outputs the fault information from the output device 53 when it includes the audio information. The indication may also include a hierarchical indication.

The controller 51 obtains the fault type symbol 525 that identifies a type of the fault by referring to the fault type management table 521, a location symbol 526 that identifies a location of the fault by referring to the fault location management table 522, and prepares the icon 512 by combining both symbols 525 and 526 with each other. The controller 51 indicates or outputs the prepared icon 512 from the output device 53.

When the fault information includes a countermeasure to the fault or a signal corresponding to the fault, the controller 51 obtains the countermeasure by referring to the fault countermeasure management table 523, and indicates or outputs it from the output device 53.

Thus, even when the communication apparatus 50 is located apart from the management apparatus 10, it is possible to promptly inform a user of the communication apparatus 50 of the event and a description of the fault in the network. Thus, the user of the communication apparatus 50 may obtain detailed information by returning to the management apparatus 10, contacting a maintenance person, a user of, or a person near the faulty device using the communication apparatus 50.

Further, the present invention is not limited to these preferred embodiments, and various modifications and variations may be made without departing from the scope of the invention. For example, although the present embodiment describes that the administrator of the management apparatus 10 is in possession of the communication apparatus 50, a maintenance person or a user of the faulty device may have the communication apparatus 50, or the communication apparatus 50 may be located near the faulted apparatus. The network communication system 1 may include many communication apparatuses, and the management apparatus 10 may send the fault information to the communication apparatus 50 of the administrator of the management apparatus 10 and the communication apparatus 50 of a maintenance person at the same time. Such a simultaneous communication is convenient when the administrator is absent from the company. In that case, the management apparatus 10 may change the fault information depending upon a type of the communication apparatus 50. For example, the management apparatus 10 may control the amount of data transmitted and a type of data (i.e., audio, image, etc.) depending upon a type of the communication apparatus 50.

According to the inventive network management apparatus and method, communication apparatus, and network system, the wireless communication module of a simple and less expensive structure can be used for radio transmission of fault information. Thereby, a user of the communication apparatus may promptly receive the fault information, and the administrator may perform another job function since he does not have to remain located near the management apparatus.

The foregoing description details certain embodiments of the invention. It will be appreciated, however, that no matter how detailed the foregoing appears in text, the invention can be practiced in many ways. The scope of the invention should therefore be construed in accordance with the appended claims and any equivalents thereof.

What is claimed is:

1. A management apparatus configured to manage a network, comprising:
a controller configured to generate fault information upon detection of a fault in the network, wherein the fault information includes a description of the fault; and
a wireless communication module configured to transmit, via radio frequencies, the fault information to a communication apparatus external to the network.

2. The management apparatus of claim 1, wherein the description of the fault includes a type of the fault.

3. The management apparatus of claim 2, wherein the type of the fault includes a fault in a line in the network.

4. The management apparatus of claim 2, wherein the type of the fault includes a fault in a network device connected to the network.

5. The management apparatus of claim 1, wherein the description of the fault includes a location of the fault.

6. The management apparatus of claim 1, wherein the fault information includes audio information, and wherein the wireless communication module includes a converter configured to convert the audio information into a radio signal.

7. The management apparatus of claim 1, wherein the fault information includes image information, and wherein the wireless communication module includes a converter configured to convert the image information into a radio signal.

8. The management apparatus of claim 1, wherein a managed device is connected to the network, and the management apparatus manages the network by monitoring a connection status and a configuration status of the managed device.

9. The management apparatus of claim 1, wherein the wireless communication module is a Bluetooth module and the fault information is transmitted using the Bluetooth protocol.

10. A management system for managing a network, comprising:
a management apparatus configured to manage a network, the management apparatus comprising a controller and a wireless communication module, wherein the controller is configured to generate fault information upon detection of a fault, wherein the fault information includes a description of the fault, and wherein the wireless communication module is configured to transmit the fault information via radio frequencies; and
a communication apparatus configured to communicate with the management apparatus and to receive the fault information via radio frequencies.

11. The management system of claim 10, wherein the communication apparatus is a portable terminal of an administrator of the management apparatus.

12. The management system of claim 10, wherein the communication apparatus is a network device connected to the network of an administrator of the management apparatus.

13. The management system of claim 10, wherein a managed device is connected to the network, wherein the management apparatus manages the network by monitoring a connection status and a configuration status of the managed device, wherein the fault information includes a countermeasure instruction to eliminate the fault, and wherein the communication apparatus is the managed device.

14. The management system of claim 10, wherein the wireless communication module is a Bluetooth module, and wherein the Bluetooth communication module is configured to transmit the fault information using the Bluetooth protocol.

15. A communication apparatus configured to communicate with a management apparatus, wherein the management apparatus is configured to manage a network, the communication apparatus comprising:
a wireless communication module configured to receives fault information from the management apparatus via a wireless communication channel, wherein the fault information comprises a description of a fault of the network; and
an output device configured to output the description of the fault from the fault information received from the wireless communication module.

16. The communication apparatus of claim 15, wherein the wireless communication module includes a converter configured to convert a radio signal into audio information, and wherein the output device includes a speaker configured to output the audio information.

17. The communication apparatus of claim 15, wherein the wireless communication module includes a converter configured to convert a radio signal into image information, and wherein the output device includes a display configured to display the image information.

18. The communication apparatus of claim 15, further comprising a memory configured to store a symbol that identifies the description of the fault, and wherein the output device includes a display configured to display the symbol.

19. The communication apparatus of claim 18, wherein the symbol is an icon, and wherein the display hierarchically indicates details of the description of the fault when the icon is selected.

20. The communication apparatus of claim 15, wherein the description of the fault includes information on a type of the fault and a location of the fault, wherein the output device includes a display, and wherein the communication apparatus further comprises:
a first memory configured to store a first symbol that identifies the type of the fault;
a second memory configured to store a second symbol that identifies the location of the fault; and
a controller that generates a third symbol by combining the first symbol with the second symbol in accordance with the fault information, wherein the display of the output device indicates the third symbol.

21. The communication apparatus of claim 20, wherein the symbol is an icon, and wherein the display hierarchically indicates details of the description of the fault when the icon is selected.

22. The communication apparatus of claim 15, further comprising a memory configured to store a countermeasure instruction to remove the fault, and wherein the output device further outputs the countermeasure information that corresponds to the description of the fault.

23. The communication apparatus of claim 15, wherein the wireless communication module is a Bluetooth module configured to receive the fault information via the Bluetooth protocol.

24. A method of managing a network, the method comprising:
generating, when detecting a fault in the network, fault information including a description of the fault of the network; and
transmitting, via radio frequencies, the fault information to a communication apparatus external to the network.

25. The method of claim 24, wherein generating fault information further comprises changing the description of the fault in accordance with a type of the communication apparatus.

26. The method of claim 24, wherein the fault information is transmitted using Bluetooth.

27. A computer readable medium that includes a program executing the method comprising:
generating, when detecting a fault in a network, fault information including a description of the fault of the network; and
transmitting, via radio frequencies, the fault information to a communication apparatus external to the network.

28. The computer readable medium of claim 27, wherein the fault information is transmitted using the Bluetooth protocol.

29. A system for managing a network, comprising:
means for generating, when detecting a fault in the network, fault information including a description of the fault of the network; and
means for transmitting, via radio frequencies, the fault information to a communication apparatus external to the network.

30. The system of claim 29, wherein the means for transmitting is a Bluetooth module.

31. A communication apparatus, configured to communicate with a management apparatus that manages a network, comprising:
means for receiving fault information, via radio frequencies, from the management apparatus, wherein said fault information includes a description of a fault of the network; and
means for outputting the description of the fault from the fault information received.

32. The communication apparatus of claim 31, wherein the means for receiving fault information is a Bluetooth module.

33. A network system, comprising:
a management device configured to manage a network, comprising a controller and a Bluetooth module, wherein the controller is configured to generate fault information in response to detection of a fault, wherein the fault information includes a description of the fault, and wherein the Bluetooth module transmits the fault information using a Bluetooth communication protocol; and
a communication device configured for wireless communication with the management device and to receive the fault information via the Bluetooth module.

34. The network system of claim 33, wherein the management device is further configured to monitor a connection status of a device connected to the network.

35. The network system of claim 33, wherein the management device is further configured to monitor a configuration status of a device connected to the network.

36. The network system of claim 33, wherein the communication device is a cellular telephone.

37. The network system of claim 33, wherein the network is a local area network of computing devices.

38. A method of managing a network, wherein a management device is connected to a network and configured to manage the network, the method comprising:
generating fault information in response to detection of a fault in the network; and
transmitting the fault information to a communication apparatus external to the network using a Bluetooth communication protocol.

39. A network system, comprising:
a management device configured to manage a network, comprising a controller and a Bluetooth module, wherein the controller is configured to generate fault information in response to detection of a fault, wherein the fault information includes a description of the fault and a location of the fault, and wherein the Bluetooth module transmits the fault information using a Bluetooth communication protocol; and
a communication device configured for wireless communication with the management device and to receive the fault information via the Bluetooth module, and wherein the communication device includes an indication device comprising either a display configured to display a symbol representative of the fault information or an audio output device configured to output audio information representative of the fault information.
